(19) United States
(12) Patent Application Publication
(10) Pub. No.: US 2003/0056888 A1
(43) Pub. Date: Mar. 27, 2003

(54) Wrapping material having surface ornamentation for wrapping holiday items and methods

(76) Inventor: Donald E. Weder, Highland, IL (US)

Correspondence Address: Richard A. Nelson, DUNLAP,CODDING & ROGERS, P.C., 9400 North Broadway, Suite 420, Oklahoma City, OK, 73114, US

(21) Appl. No.: 10/234,306

(22) Filed: Sep. 3, 2002

Related U.S. Application Data
(63) Continuation-in-part of application No. 09/460,208, filed on Dec. 13, 1999, now abandoned.
Application No. 09/460,208 is a continuation of application No. 09/061,426, filed on Apr. 16, 1998, now abandoned.

(51) Int. Cl. B65C 1/00

(52) U.S. Cl. 156/212

(57) ABSTRACT

A decorative cover or wrapping formed from a sheet of material having decorative design thereon for wrapping a holiday item such as an Easter egg or a holiday ornament, which may include forming indicia and an extension which is integral or non-integral to the sheet of material which is used as at least a portion of the decoration. Methods of decoratively covering Easter eggs and holiday ornaments are also disclosed.

### CROSS REFERENCE TO RELATED APPLICATIONS

The present application is a continuation-in-part of U.S. Ser. No. 09/460,208, filed Dec. 13, 1999; which is a continuation of U.S. Ser. No. 09/061,426, filed Apr. 16, 1998, now abandoned.

### STATEMENT REGARDING FEDERALLY SPONSORED RESEARCH OR DEVELOPMENT

Not applicable.

### SUMMARY OF THE INVENTION

This invention generally relates to decorative covers and wrappings provided for holiday ornaments and Easter eggs, and methods of using same.

Holiday items such as Easter eggs and holiday ornaments have traditionally been decorated and utilized around or for a holiday. Easter eggs have been colored and had various decorations placed on them. Holiday ornaments have been formed many different ways.

Candy eggs and other candy holiday forms have been wrapped to keep the candy fresh and uncontaminated. Holiday ornaments are usually preformed in any number of shapes.

Therefore, there is a need felt within the art for a wrapping material which provides an easy and quick way to form a decorative cover for these holiday items, and which also provides a way to take an item decorated for one holiday and wrapping the wrapping material thereabout to provide a decorative cover for a different holiday. Such a wrapping material may also provide customized features, such as, but not by way of limitation, the recipient's name. The wrapping material may provide wrapping instructions on one side thereof to instruct the user on ease of wrapping. The wrapping material will have at least one design indicia on at least a portion of one surface thereof. The wrapping material may also include a bonding material disposed on at least a portion of one surface thereof to effect an easy and complete closure about the holiday item. In addition, the wrapping material may have extensions which extend therefrom for an additional aesthetic and decorative effect. In addition, closure decorations may be utilized to create a “finished effect” for the overall decoration. Examples of such closure decorations include, but are not limited to, cotton balls, hats, jewelry, scarves, buttons, eyes, nose, ears, hair, clothing, and the like.

It is a goal of the present invention to provide a wrapping material having a design indicia thereon to permit a user to quickly and easily wrap the wrapping material about a holiday item to provide a decorative cover. It is an objective of the present invention to provide a wrapping material having design indicia thereon which, when wrapped about an Easter egg or a holiday ornament, provides a customized decoration for the Easter egg or holiday ornament. It is a further goal of the present invention to provide a wrapping material having a design indicia thereon, and which has an extension integrally or non-integrally connected thereto which extends a distance from the wrapping. Such a wrapping material and extension provide a more multidimensional decorative effect for an Easter egg or a holiday ornament. It is a further objective of the present invention to provide a wrapping material which permits an ornament for one holiday to be transformed into an ornament for a different holiday. It is a further goal of the present invention to provide a wrapping material having wrapping instructions in the form of forming indicia disposed on at least a portion of one surface thereof. It is a further object of the present invention to provide a wrapping material having a bonding material disposed on at least a portion of one surface thereof, to effect an easy and complete closure of the decorative cover about the holiday item. It is a further goal of the present invention to provide a shape sustaining element which may be included in the primary wrapping material and/or in any additional sheet of material utilized, such as a sheet extension. It is a further objective of the present invention to utilize closure decorations which may be utilized to complete and/or compliment the overall decoration of the holiday item.

### BRIEF DESCRIPTION OF THE DRAWINGS

FIG. 1 is a perspective view of a sheet of material constructed in accordance with the present invention, the sheet of material having a decorative design on at least a portion of an upper surface thereof and an edge upwardly turned for purposes of illustration only.

FIG. 2 is a bottom plan view of a lower surface of the sheet of material of FIG. 1, the sheet of material having forming indicia disposed on at least a portion of the lower surface thereof.

FIG. 3 is a perspective view of an egg disposed on the forming indicia disposed on the lower surface of the sheet of material of FIG. 2.

FIG. 4 is a perspective view of the sheet of material of FIGS. 1-3 partially wrapped about the egg.

FIG. 5 is a rear plan view of a decorative cover for the egg formed from the sheet of material of FIGS. 1-3.

FIG. 6 is a front plan view of the decorative cover of FIG. 5, showing the decorative design of the sheet of material disposed on an outer surface of the decorative cover.

FIG. 7 is a perspective view of another embodiment of a sheet of material constructed in accordance with the present invention, the sheet of material having a decorative design on at least a portion of an upper surface thereof, the decorative design having arms and legs that are cut out from the sheet of material.

FIG. 8 is a perspective view of a lower surface of the sheet of material of FIG. 7, illustrating forming indicia disposed on at least a portion of the lower surface of the sheet of material.

FIG. 9 is a perspective view of an egg disposed on the forming indicia disposed on the lower surface of the sheet of material of FIG. 8.

FIG. 10 is a perspective view of a decorative cover formed by wrapping the sheet of material of FIGS. 7-9 about the egg, the decorative cover having extensions which extend away from the wrapping.

FIG. 11 is a perspective view of the decorative cover of FIG. 10, showing the decorative design of the sheet of material disposed on an outer surface of the decorative cover and the extensions of the decorative cover extending away from the decorative cover.

FIG. 12 is a top plan view of yet another embodiment of a sheet of material constructed in accordance with the present invention, the sheet of material having a decorative design disposed on at least a portion of an upper surface thereof and having one edge upwardly turned for illustration purposes only.

FIG. 13 is a perspective view of a sheet of material that forms an extension, the extension having a decorative design disposed on at least a portion of one surface thereof and having one edge thereof upwardly turned for illustration purposes only.

FIG. 14 is a bottom plan view of a lower surface of the sheet of material of FIG. 12, illustrating forming indicia disposed on at least a portion of the lower surface of the sheet of material.

FIG. 15 is a perspective view of an egg disposed on the forming indicia on the lower surface of the sheet of material of FIG. 14.

FIG. 16 is a rear plan view of a decorative cover formed by wrapping the sheet of material of FIGS. 12, 14 and 15 about the egg.

FIG. 17 is a side elevational view of the decorative cover of FIG. 16 having the extension of FIG. 13 attached to a portion of an outer surface thereof.

FIG. 18 is a side elevational view of the decorative cover of FIG. 17 having the extension attached thereto and having a closure decoration attached to a portion of the outer surface thereof.

FIG. 19 is a top plan view of still another embodiment of the a sheet of material constructed in accordance with the present invention, the sheet of material having a decorative design on a portion of an upper surface thereof and having one edge thereof upwardly turned for illustration purposes only.

FIG. 20 is a top plan view of a sheet of material that forms an extension, the extension having a decorative design disposed on at least a portion of one surface thereof and having one edge thereof upwardly turned for illustration purposes only, the sheet of material forming the extension further having a shape sustaining element thereon.

FIG. 21 is a bottom plan view of a lower surface of the sheet of material of FIG. 19, the sheet of material having forming indicia disposed on at least a portion of the lower surface thereof.

FIG. 22 is a perspective view of an egg disposed on the forming indicia on the lower surface of the sheet of material of FIG. 21.

FIG. 23 is a rear plan view of a decorative cover formed by wrapping the sheet of material of FIGS. 19, 21 and 22 about the egg.

FIG. 24 is a side elevational view of the decorative cover of FIG. 16 having the extension of FIG. 13 attached to a portion of an outer surface thereof, the shape sustaining element of the extension permitting positioning thereof.

FIG. 25 is a side elevational view of the decorative cover of FIG. 24 having the extension attached thereto and having a closure decoration attached to a portion of the outer surface thereof.

FIG. 26 is a top plan view of still a further embodiment of a sheet of material constructed in accordance with the present invention, the sheet of material having a decorative design disposed on at least a portion of an upper surface thereof and having one edge upwardly turned for illustration purposes only.

FIG. 27 is a perspective view of a closure decoration having a bonding material disposed on a portion thereof.

FIG. 28 is a bottom plan view of a lower surface of the sheet of material of FIG. 26, the sheet of material having forming indicia disposed on at least a portion of the lower surface thereof.

FIG. 29 is a perspective view of an egg disposed on the forming indicia on the lower surface of the sheet of material of FIG. 28.

FIG. 30 is a rear plan view of a decorative cover formed by wrapping the sheet of material of FIGS. 26, 28 and 29 about the egg.

FIG. 31 is a front elevational view of the decorative cover of FIG. 30 having the closure decoration of FIG. 27 attached to a portion of the outer surface thereof.

### DETAILED DESCRIPTION OF THE INVENTION

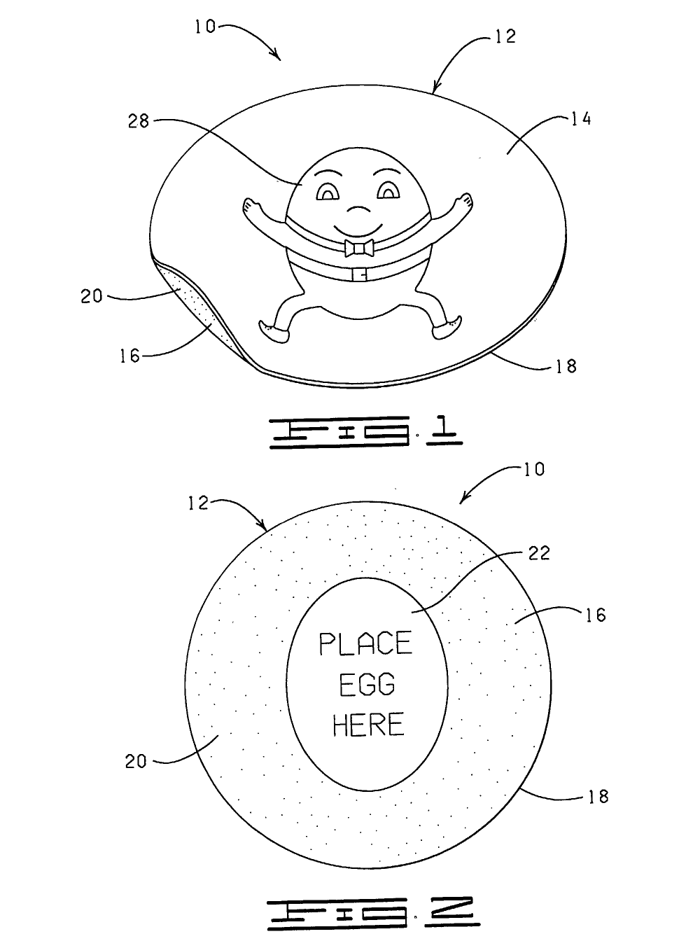

Description of FIGS. 1-6

Easter eggs and holiday ornaments have existed for a number of years. A common problem with such ornaments is in easily decorating Easter eggs, or, alternatively, customizing or changing an existing Easter egg or holiday ornament to provide an ornament for a different occasion or holiday.

The present invention contemplates a wrapping material comprising at least one sheet of material having a decorative design disposed on at least a portion of one surface thereof. The sheet of material is wrapped about the Easter egg and/or holiday ornament to decorate the Easter egg or holiday ornament, or to change and/or customize the decoration of the Easter egg or the holiday ornament.

Referring now to FIGS. 1-6, designated therein by the general reference numeral 10 is a wrapping material for wrapping Easter eggs and holiday ornaments. It will be appreciated that Easter eggs and holiday ornaments are referred to at times herein collectively as “holiday items”. The wrapping material 10 comprises at least one sheet of material 12. The sheet of material 12 has an upper surface 14, a lower surface 16, and an outer periphery 18, and in the present embodiment is shown as having a round shape.

The sheet of material 12 also frequently has a bonding material 20 disposed on at least a portion of one of the upper and lower surfaces 14 and 16 of the sheet of material 12. The term “bonding material” as used herein includes an adhesive bonding material, such as a pressure sensitive adhesive, and a cohesive bonding material. Where the bonding material is a cohesive bonding material, a similar cohesive bonding material must be placed on the adjacent surface for bondingly contacting and bondingly engaging with the cohesive material.

The term “bonding material” as used herein also includes materials which are heat sealable and, in this instance, the adjacent portions of the material must be brought into contact and then heat must be applied to effect the seal. The term “bonding material” as used herein also includes materials which are sonicly sealable and vibratorally sealable. The term “bonding material” when used herein also means a lacquer. In some instances, a sealing lacquer is utilized, which may be applied to the sheet of material 12 and, in this instance, heat, sound waves, or vibrations also must be applied to effect and create the sealing.

The bonding material 20 utilized in the present invention may be disposed on at least a portion of the upper surface 14 of the sheet of material 12 or alternatively, on at least a portion of the lower surface 16 of the sheet of material 12 or, in a further alternative, on at least a portion of both of the upper and lower surfaces 14 and 16 of the sheet of material 12. The bonding material 20 is disposed on the sheet of material 12 by any method of disposing a bonding material 20 on a sheet of material 12 known in the art, such as, but not by way of limitation, painting the bonding material 20 on the sheet of material 12, spraying the bonding material 20 on the sheet of material 12, immersing the sheet of material 12 in the bonding material 20, and the like. These methods of disposing a bonding material on a sheet of material are commercially available. As shown in FIG. 1, the bonding material 20 is often disposed on at least a portion of the lower surface 16 of the sheet of material 12. The bonding material 20 may be disposed in a plurality of strips of bonding material 20. It will be understood, however, that the bonding material 20 also could be applied to either surface of the sheet of material 12, or both surfaces, in the form of spaced apart spots or in any pattern, shape, or groups of patterns or shapes. That is, the bonding material 20 may be disposed in any geometric or non-geometric form and in any pattern, including covering at least one entire surface of the sheet of material 12.

The sheet of material 12 may also include forming indicia 22 disposed on at least a portion of one of the upper and lower surfaces 14 and 16 thereof. The term “forming indicia”, as used herein, will be understood to refer to any type of instructions for disposing an item, such as an egg or holiday ornament, on the sheet of material 12, such that the sheet of material 12 may be wrapped about the item to form a decorative cover for the item. The term “forming indicia”, as used herein, includes, but is not limited to, score lines, creases and/or other printed indicia including printed instructions, letters, numbers, drawings, and the like, unprinted indicia, or any combination thereof. The forming indicia 22 may comprise a pattern, or, in the alternative, the lack of a pattern on a sheet of material having a pattern in other locations.

The sheet of material 12 may be constructed of a single layer of material or a plurality of layers of the same or different types of materials. Any thickness of the sheet of material 12 may be utilized in accordance with the present invention as long as the sheet of material 12 is wrappable about an object, such as an Easter egg or a holiday ornament, or a form to create a holiday ornament, such as, but not by way of limitation, a styrofoam form, as described herein. The layers of material comprising the sheet of material 12 may be connected together or laminated or may be separate layers. The sheet of material 12 has a thickness in a range of from about 0.1 mil to about 30 mil, preferably in a range of from about 0.1 mil to about 5 mil, and more preferably in a range of from about 0.2 mil to about 3.5 mil. The sheet of material 12 is constructed of a material which is flexible.

The sheet of material 12 may be any shape, and a round shape is shown in FIGS. 1-3 only by way of example. The sheet of material 12 may be rectangular, square or any other geometric shape, or any non-geometric shape, or any combination of geometric and non-geometric and/or asymmetric shapes.

The sheet of material 12 in this embodiment is often constructed from two polypropylene films (for example, a 20″×15″ sheet of Mobil 270 ABW white opaque film laminated to a 20″×15″ sheet of Mobil 220 AB clear film) having a thickness in a range of from less than about 1.0 mil to about 2.5 mil.

It will be understood, however, that the sheet of material 12 can be constructed from any suitable material that is capable of being wrapped about a holiday item such as an Easter egg or holiday ornament. In one embodiment, the sheet of material 12 is constructed from paper (untreated or treated in any manner), foil, polymer film, fabric (woven or nonwoven or synthetic or natural), fiber, cling material, burlap, and any combination or lamination thereof.

The term “polymer film” means a man-made polymer such as a polypropylene or a naturally occurring polymer such as cellophane. A polymer film is relatively strong and not as subject to tearing (substantially non-tearable), as might be the case with paper or foil.

The sheet of material 12 may vary in color. Further, the sheet of material 12 may consist of designs or decorative patterns which are printed, etched, and/or embossed thereon using inks or other printing materials. An example of an ink which may be applied to the surface of the sheet of material 12 is described in U.S. Pat. No. 5,147,706 entitled “Water Based Ink On Foil And/Or Synthetic Organic Polymer” issued to Kingman on Sep. 15, 1992 and which is hereby expressly incorporated herein by reference. In addition, the sheet of material 12 may have various colorings, coatings, flocking and/or metallic finishes, holographic images, or other decorative surface ornamentation applied separately or simultaneously or may be characterized totally or partially by pearlescent, neon, translucent, transparent, iridescent or the like, qualities. Each of the above-named characteristics may occur alone or in combination and may be applied to at least a portion of the upper and/or lower surface of the sheet of material 12. Moreover, each surface of the sheet of material 12 may vary in the combination of such characteristics. The sheet of material 12 may be opaque, translucent or partially clear or tinted transparent.

“Cling Wrap or Cling Material” when used herein means any material which is capable of connecting to a sheet of material and/or itself upon contacting engagement during the wrapping process and is wrappable about an item whereby portions of the cling material contactingly engage and connect to other portions of the wrapping material for generally securing a sheet of material wrapped about at least a portion of the item. This connecting engagement is preferably temporary in that the wrapping material may be easily removed without tearing same, i.e., the cling material “clings” to the wrapping material.

The cling material is constructed and treated if necessary, from polyethylene such as Cling Wrap made by Glad®, First Brands Corporation, Danbury, Conn. The thickness of the cling material will, in part, depend upon the thickness of the sheet of material utilized, i.e., generally, the thicker and therefore heavier sheet of material may require a thicker and therefore stronger cling material. The cling material will range in thickness from less than about 0.2 mil to about 10 mil, and preferably less than about 0.5 mil to about 2.5 mils and most preferably from less than about 0.3 mil to about 1 mil. However, any thickness of cling material may be utilized in accordance with the present invention which permits the cling material to function as described herein.

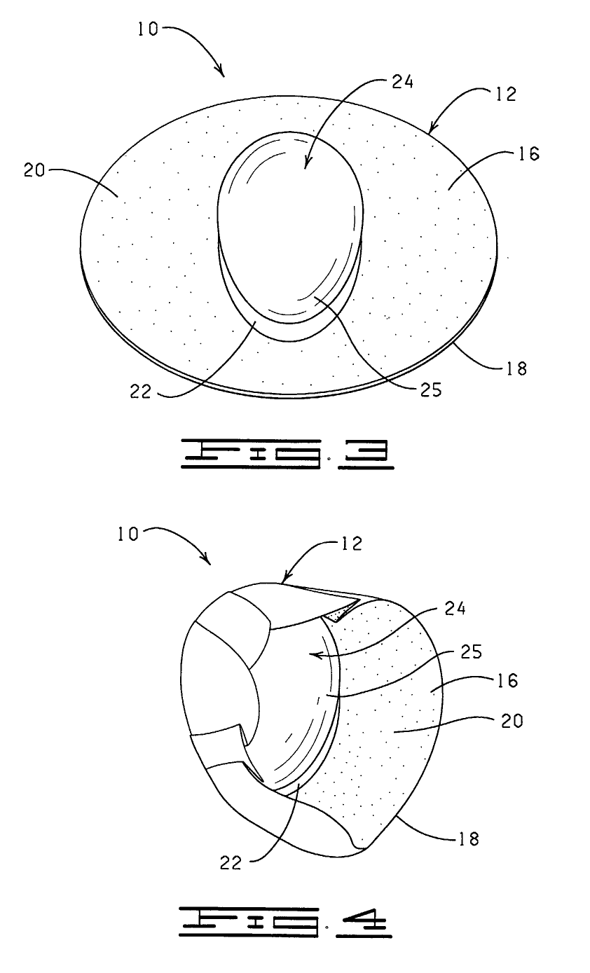

As described previously, the sheet of material 12 may be wrapped about an item 24, such as an Easter egg, holiday ornament or styrofoam form. An Easter egg 24, having an outer surface 25, is shown in FIG. 3. The term “Easter egg” as used herein includes, but is not limited to, a cooked or uncooked natural egg, an egg shell, any edible product formed in an egg shape, such as a candy egg, a chocolate egg or a wax egg, as well as any artificial eggs, any combination of the above, and the like. Artificial eggs, as used herein, may be formed of materials such as, but not by way of limitation, paper, plastic, foil, styrofoam, or any combinations of material, and the like.

The sheet of material 12 is also wrappable about a holiday ornament. The term “holiday ornament” as used herein includes, but is not limited to, Christmas ornaments for Christmas trees, such as round ball ornaments, as well as other ornaments used decoratively for other holiday and festive occasions, such as Thanksgiving, Halloween, New Year's, birthdays, anniversaries, and the like. The holiday ornament may be made of any material that will allow the holiday ornament to function in accordance with the present invention, including but not limited to, any food or combinations of food products, paper, plastic, foil, metal, styrofoam, any other material, and any combination of materials.

It will be appreciated that the sheet of material 12 may be wrapped about a pre-wrapped or otherwise pre-decorated Easter egg 24 or holiday ornament which already has an ornamentation thereon. Such an additional wrapping material 10 may be used to change the appearance of the Easter egg 24 or holiday ornament. That is, the Easter egg 24 and/or holiday ornament receives a different decoration, which can be for a different holiday or festive occasion. In another alternative, the wrapping material 10 is utilized to wrap the Easter egg 24 or holiday ornament so that the Easter egg 24 and/or holiday ornament may be customized, such as with a particular design, name and/or pattern.

The sheet of material 12 used herein may further comprise at least one scent (not shown). Examples of scents utilized herein include, but not by way of limitation, floral scents (flower blossoms, or any portion of a plant), food scents (chocolate, sugar, fruits), herb or spice scents (cinnamon), and the like. Additional examples of scents include, but are not limited to, flowers (such as roses, daisies, lilacs), plants (such as fruits, vegetables, grasses, trees), foods (for example, candies, cookies, cake), food condiments (such as honey, sugar, salt), herbs, spices, woods, roots, leaves, needles, and the like, or any combination of the foregoing. Such scents are known in the art, and are commercially available.

The scent may be disposed upon the sheet of material 12 by spraying the scent thereupon, painting the scent thereupon, brushing the scent thereupon, lacquering the scent thereupon, immersing the sheet of material 12 in a scent-containing liquid, exposing the sheet of material 12 to scent-containing gas, forming scented elements, such as, but not by way of limitation, beads, particles, and the like, which are incorporated in or disposed upon the sheet of material 12, or any combination of the foregoing.

The scent may be contained within a lacquer, or other liquid, before it is disposed upon the sheet of material 12. The scent may also be contained within a dye, ink, and/or pigment (not shown). Such dyes, inks and pigments are known in the art, and are commercially available, and may be disposed upon or incorporated in the sheet of material 12 by any method described herein or known in the art.

The sheet of material 12 may have a decorative design 26 disposed on at least a portion of one of the upper and lower surfaces 14 and 16 of the sheet of material 12, such as a portion of the upper surface 14 of the sheet of material 12, as shown in FIG. 1. The term “decorative design” as used herein will be understood to include any design that provides the sheet of material 12 and therefore the wrapping material 10 and a decorative cover formed therefrom with a decorative appearance. The term “decorative design” as used herein will be understood to include, but is not limited to, a pattern, numbers, letters, characters (such as, but not by way of limitation, comic or cartoon characters), and the like. The term “decorative design” may include any geometric and/or asymmetric shape, or any combination of shapes, or any combination of the foregoing. As shown in FIG. 1, the decorative design 26 on the sheet of material 12 is a “Humpty Dumpty” design.

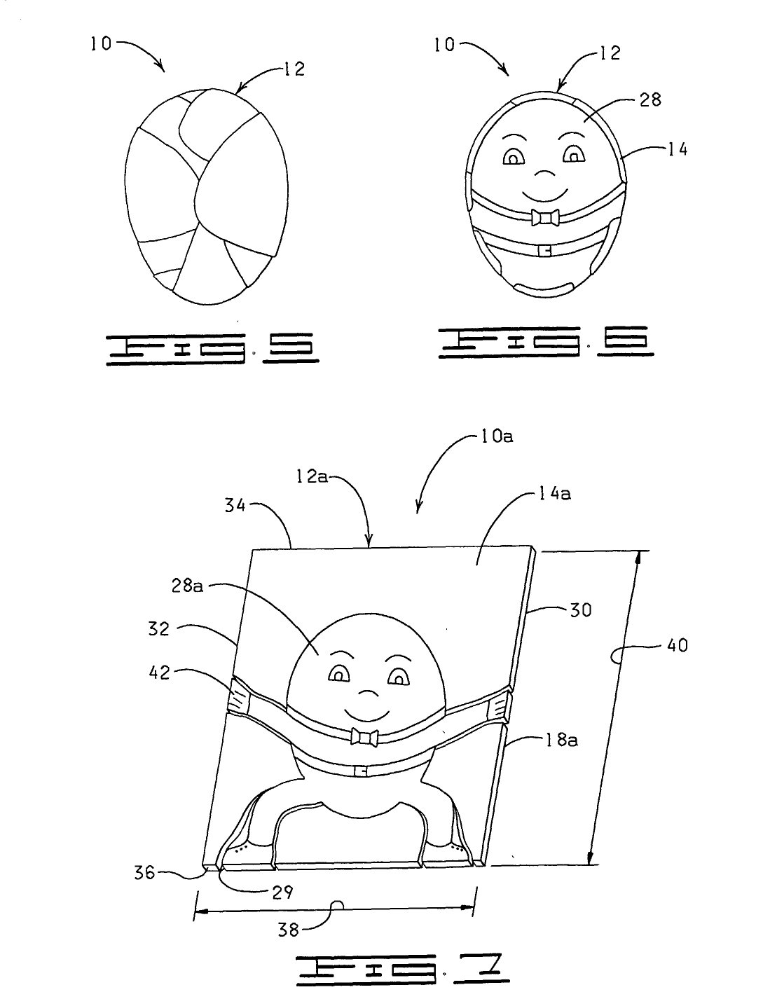

In a method of use, an egg 24, such as an Easter egg, is provided and disposed on the lower surface 16 of the sheet of material 12 in accordance with the forming indicia 22, as shown in FIG. 3. The sheet of material 12 is then wrapped about the egg 24 as shown in FIGS. 3-6, with the bonding material 20 on the lower surface 16 of the sheet of material 12 disposed adjacent the outer surface 25 of the egg 24 such that when the sheet of material 12 is gathered together about the egg 24 in an overlapping manner as shown in FIGS. 4-6, the bonding material 20 bondingly connects the sheet of material 12 to the egg 24, thereby forming a decorative cover 28 for the egg 24. The decorative design 26 on the sheet of material 12 is positioned such that the decorative design 26 is well illustrated on an outer surface 29 of the decorative cover 28, as shown in FIG. 6, and the sheet of material 12 is gathered together in an overlapping manner on the opposite side of the outer surface 29 of the decorative cover 28, as illustrated in FIG. 5.

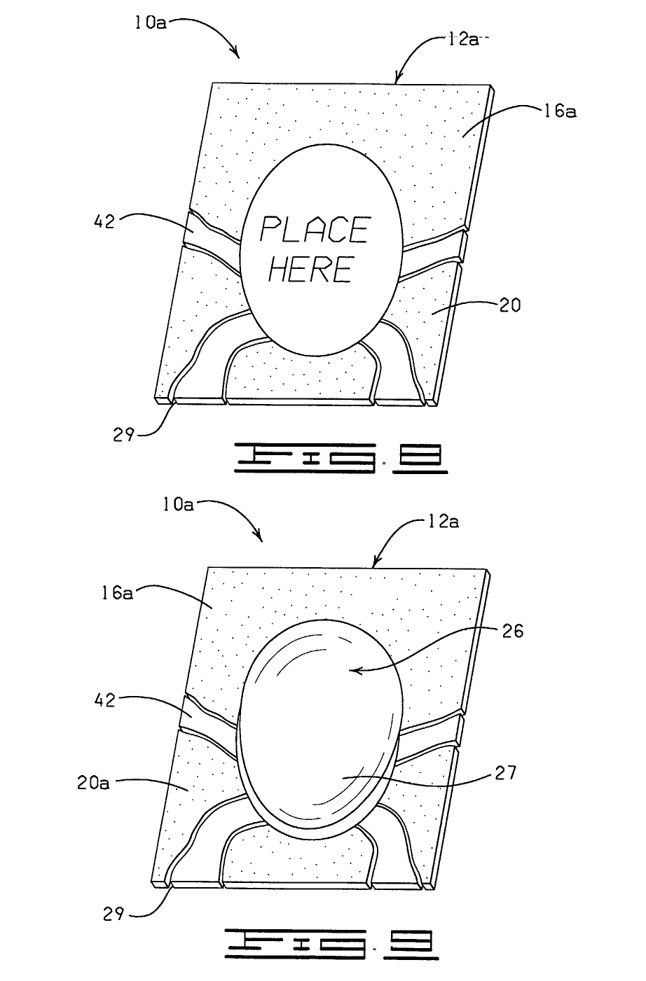

Description of FIGS. 7-11

FIGS. 7-11 illustrate another embodiment of the present invention. FIG. 7 shows a wrapping material 10a formed of a sheet of material 12a which is constructed similar to the sheet of material 12 described in detail before and shown in FIGS. 1-6, except that the sheet of material 12a is rectangular, and the sheet of material 12a has cut portions 31 in the sheet of material 12a, which will be described in detail herein below.

The sheet of material 12a is provided with an upper surface 14a, a lower surface 16a, and an outer periphery 18a. The outer periphery 18a of the sheet of material 12a comprises a first side 30, a second side 32, a third side 34 and a fourth side 36. The sheet of material 12a has a length 38 extending between the first and the second sides 30 and 32, respectively, of the sheet of material 12a. The sheet of material 12a also has a width 40 extending between the third and fourth sides 34 and 36, respectively, of the sheet of material 12a.

The sheet of material 12a has a “Humpty Dumpty” decorative design 26a printed on a portion of the upper surface 14a thereof, but the arms and legs of the Humpty Dumpty of the decorative design 26a are defined by cut portions 31 extending into the sheet of material 12a. When the sheet of material 12a is wrapped about the outer surface 25 of the egg 24 or holiday ornament, the arms and legs of the “Humpty Dumpty” decorative design 26a act as a plurality of extensions 42 (only one extension designated by the numeral 42), and extend a distance away from forming indicia 22a disposed on a portion of the lower surface 16a of the sheet of material 12a.

The sheet of material 12a may also have one or more extensions 42 thereon or connected thereto. Each extension 42 may be integrally formed with the sheet of material 12a, or may be formed from a separate sheet of material 12a and therefore are non-integrally connected to the sheet of material 12a. Each extension 42 is formed with and/or connected to the sheet of material 12a such that the extension 42 extends a distance away from the sheet of material 12a. It will be appreciated that each extension 42 has an upper surface 44, a lower surface 46 and an outer periphery 48.

As illustrated in FIGS. 7-11, the plurality of extensions 42 are formed integrally with the sheet of material 12a. However, it will be appreciated that each of the plurality of extensions 42 may be formed from a separate extension sheet of material, and may be connected to the sheet of material 12a before, during or after the sheet of material 12a is used to wrap an object, such as an egg 24 or a holiday ornament.

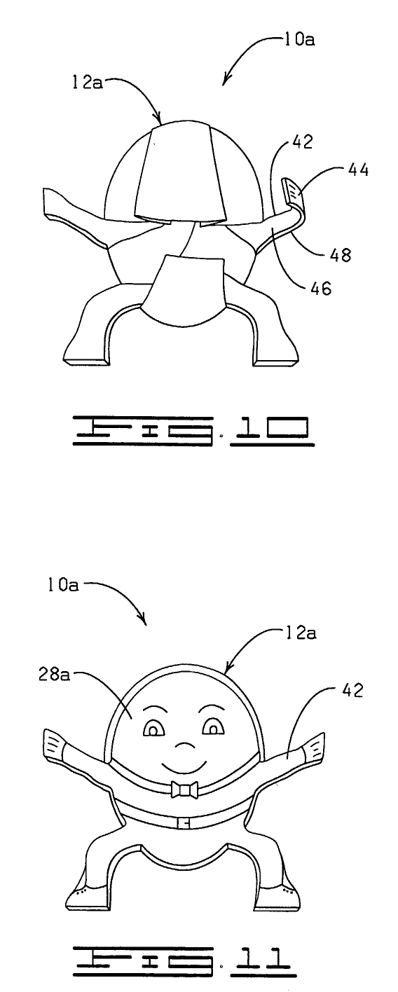

In a method of use illustrated in FIGS. 9-11, the egg 24 is disposed on the lower surface 16a of the sheet of material 12a in accordance with the forming indicia 22a. The sheet of material 12a is then wrapped about the egg 24 with bonding material 20a on a portion of the lower surface 16a of the sheet of material 12a disposed adjacent the outer surface 25 of the egg 24 such that when the sheet of material 12a is wrapped about the egg 24, the sheet of material 12a is gathered together in an overlapping manner about the egg 24 and bondingly connected to the egg 24 via the bonding material 20a, thereby forming a decorative cover 28a. The decorative design 26a comprising the torso of the “Humpty Dumpty” design is positioned on the decorative cover 28a such that the torso is well illustrated on at least a portion of an outer surface 29a of the decorative cover 28a, as shown in FIG. 11, and the plurality of extensions 42 (the “arms” and “legs” of the “Humpty Dumpty” design) extend a distance away from the outer surface 29a of the decorative cover 28a, providing a different visual, aesthetic and decorative effect. The sheet of material 12a is gathered together in an overlapping manner on the opposite side of the outer surface 29a of the decorative cover 28a, as illustrated in FIG. 10.

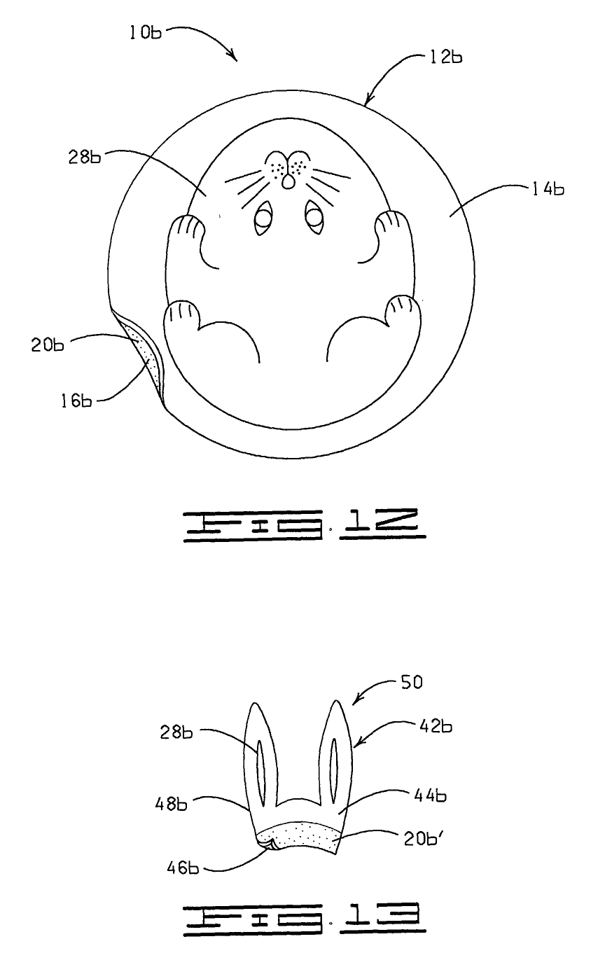

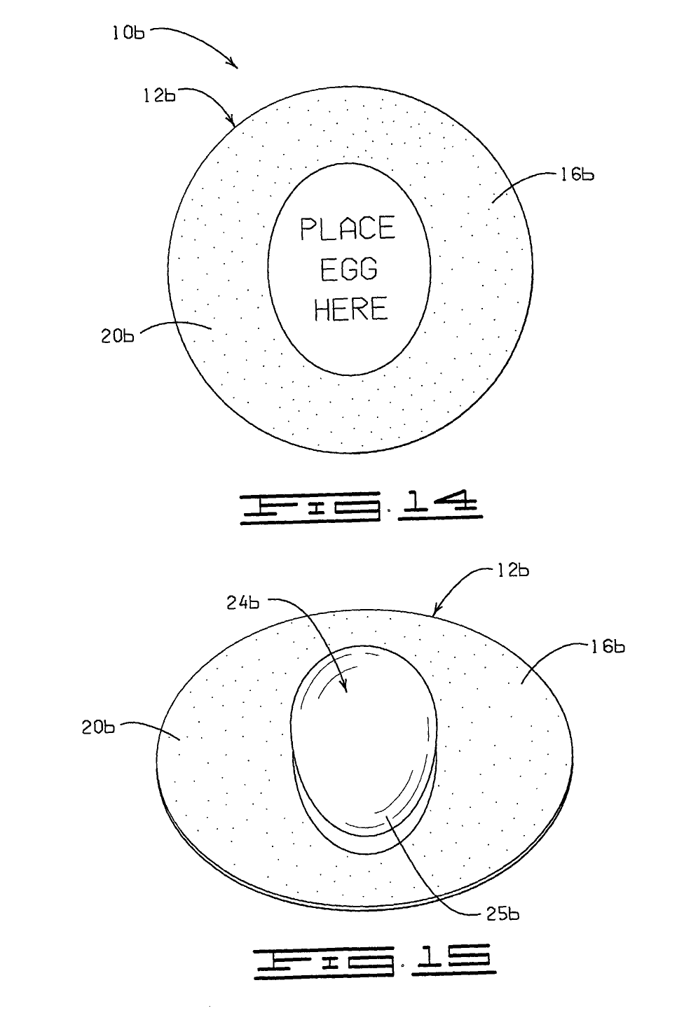

Description of FIGS. 12-18

FIGS. 12-18 illustrate another embodiment of the present invention. FIG. 12 shows a wrapping material 10b comprising a sheet of material 12b which is constructed similar to the sheets of material 12 and 12a described in detail before and shown in FIGS. 1-11, except that the sheet of material 12b has a different design forming a decorative design 26b.

As seen in FIG. 13, an extension 42b is formed from a second sheet of material 50 which has an upper surface 44b, a lower surface 46b and an outer periphery 48b. It will be appreciated that the second sheet of material 50 forming the extension 42b may have any of the characteristics previously described herein for the sheets of material 12-12b. The outer periphery 48b of the extension 42b, in this embodiment, forms a decorative design 52, i.e., “rabbit ears”. The second sheet of material 50 also has a bonding material 54 disposed on at least a portion of one of the upper and lower surfaces 44b and 46b thereof, such as the lower surface 46b, as shown in FIG. 13.

The decorative design 26b printed on the sheet of material 12b is a rabbit without ears. The “ears” of the rabbit are provided via the extension 42b formed from the second sheet of material 50, as previously noted. The sheet of material 12b is wrapped about the outer surface 25 of the egg 24 to provide a decorative cover 28b, and then the extension 42b is attached to the decorative cover 28b in the anatomically appropriate area of the design, as illustrated in FIG. 17. The extension 42b extends a distance away from an outer surface 29b of the decorative cover 28b, thereby providing a more multidimensional effect of the design.

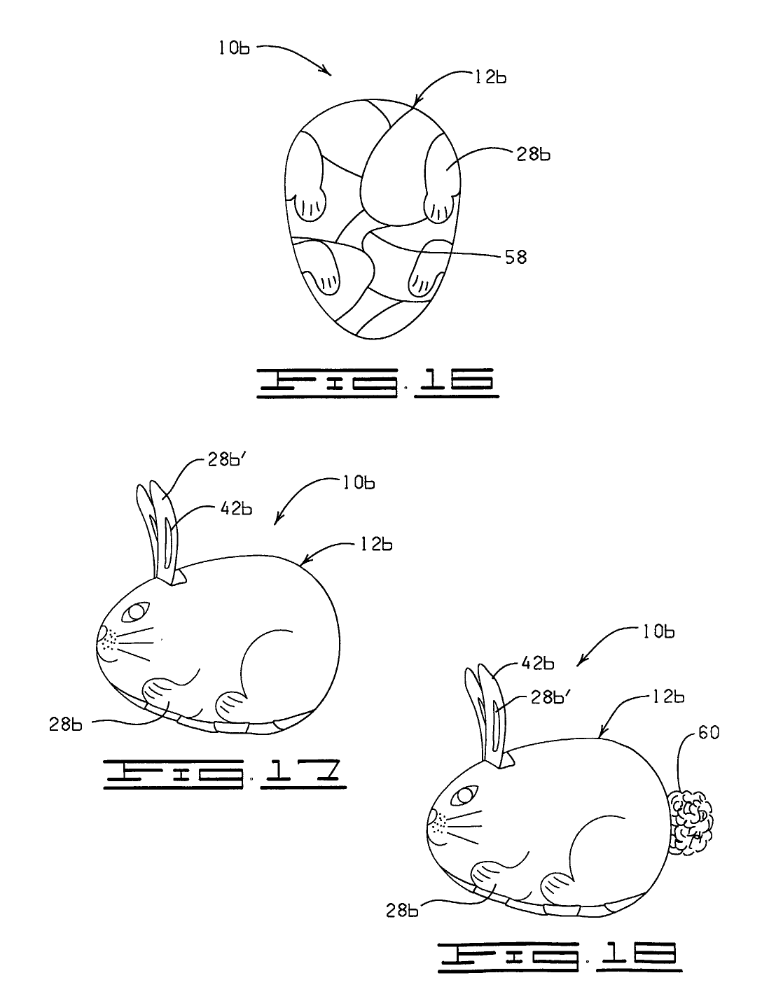

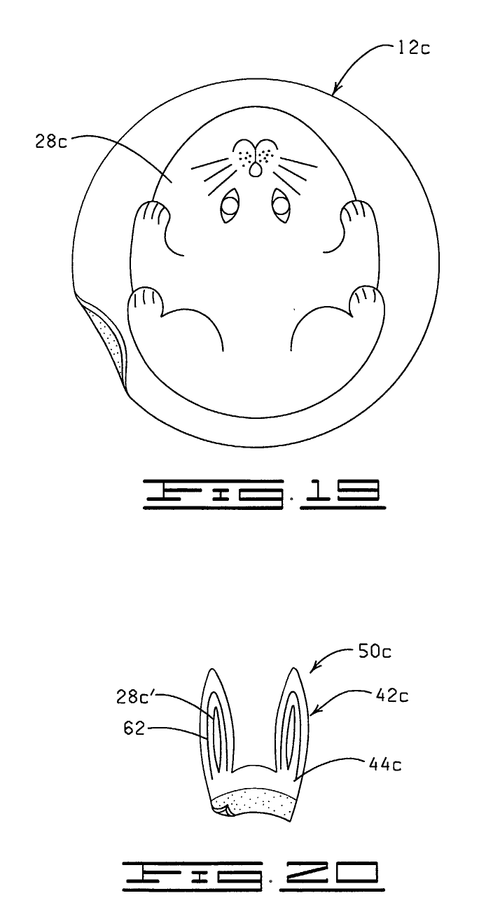

In a method of use, illustrated in FIGS. 15-18, the egg 24 is disposed on forming indicia 22b on the lower surface 16b of the sheet of material 12b, and the sheet of material 12b is wrapped about the egg 24 such that bonding material 20b on at least a portion of the lower surface 16b of the sheet of material 12b disposed adjacent the outer surface 25 of the egg 24 bondingly connects the sheet of material 12b to the egg 24 and holds the sheet of material 12b in the wrapped position, thereby providing the decorative cover 28b. When the sheet of material 12b is wrapped completely about the egg 24, the decorative design 26b on the sheet of material 12b comprising the torso of the “Rabbit” design is positioned such that the torso is well illustrated on a portion of an outer surface 29b of the decorative cover 28b, as shown in FIGS. 17-18. The extension 42b is positioned on the decorative cover 28b such that the extension 42b connects to the decorative design 26b at a top of the design of the rabbit's head, therefore connecting the extension 42b in an anatomically correct manner, showing the decorative design 52 of the extension 42b, namely, the rabbit ears, connected to the top of the design of the rabbit's head on the decorative design 26b. The extension 42b extends a distance away from the outer surface 29b of the decorative cover 28b, providing a different visual, aesthetic and decorative effect. The sheet of material 12b is gathered together in an overlapping manner on the opposite side of the outer surface 29b of the decorative cover 28b, as illustrated in FIG. 16.

A closure decoration 60, such as, for example only, a cotton ball (representing a rabbit's tail) may also be added to the decorative cover 28b, in the correct anatomical location, as shown in FIG. 18. It will be appreciated that other types of closure decorations 60 may be added to each of the embodiments contemplated herein and that fall within the scope of the present invention, and others will suggest themselves to one of ordinary skill in the art. Such closure decorations 60 include, but are not limited to, hats, clothing, jewelry, buttons, hair, eyes, ears, and the like. However, the closure decoration 60 is used to complete the overall design, and is therefore not limited to creating and/or holding the sheet of material 12b in an overlapped position.

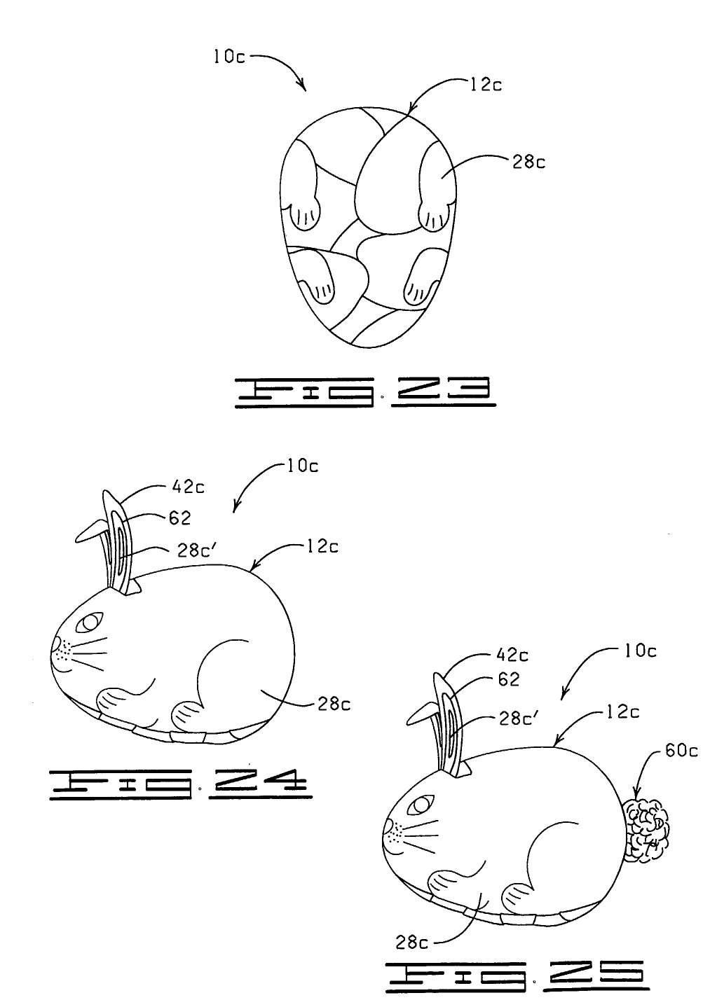

Description of FIGS. 19-25

FIGS. 19-25 illustrate another embodiment of the present invention. FIG. 19 shows a sheet of material 12c which is constructed exactly like the sheet of material 12b described in detail before in relation to FIGS. 12 and 14-18.

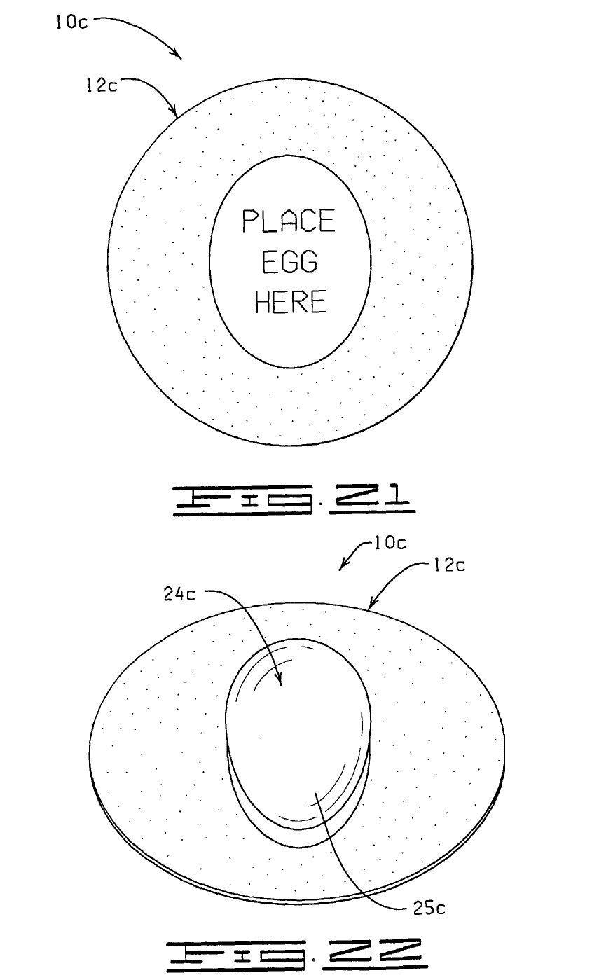

As shown in FIG. 20, an extension 42c is provided that is constructed similar to the extension 42b described in detail and illustrated previously in FIG. 13, except that a shape sustaining element 62 is connected to an upper surface 44c of a second sheet of material 50c from which the extension 42c is formed.

The term “shape sustaining element” as used herein refers to any element that substantially maintains its shape and provides support to a material attached thereto to prevent substantial distortion of such material. Examples of materials that may be used as shape sustaining elements are known in the art and include, but are not limited to, wire, metal, plastic, fiber, wood, cardboard, combinations thereof, and the like.

In a method of use, illustrated in FIGS. 21-25, the egg 24 is disposed on forming indicia 22c on a portion of a lower surface 16c of the sheet of material 12c, and the sheet of material 12c is wrapped about the egg 24 to form a decorative cover 28c in the same method as described previously in relation to FIGS. 15-18. Similarly, the extension 42c is positioned on the decorative cover 28c such that the extension 42c connects to the decorative design 26c on the decorative cover 28c at a top of the design of the rabbit's head, therefore connecting the extension 42c in an anatomically correct manner and displaying a decorative design 52c of the extension 42c, namely, the rabbit ears, connected to the top of the design of the rabbit's head on the decorative design 26c. The shape sustaining element 62 of the extension 42c may be positioned to extend the extension 42c a distance away from an outer surface 29c of the decorative cover 28c. Further, the shape sustaining element 62 may be positioned to provide a different visual, aesthetic and decorative effect. It will be appreciated that the shape sustaining element 62 may, alternatively, be connected to the sheet of material 12c for shaping the sheet of material 12c, or any portion of the sheet of material 12c. In a further alternative, the shape sustaining element 62 may be connected to both the sheet of material 12c and the extension 42c, or may form a plurality of shape sustaining elements 62 which are connected to the sheet of material 12c and/or the extension 42c.

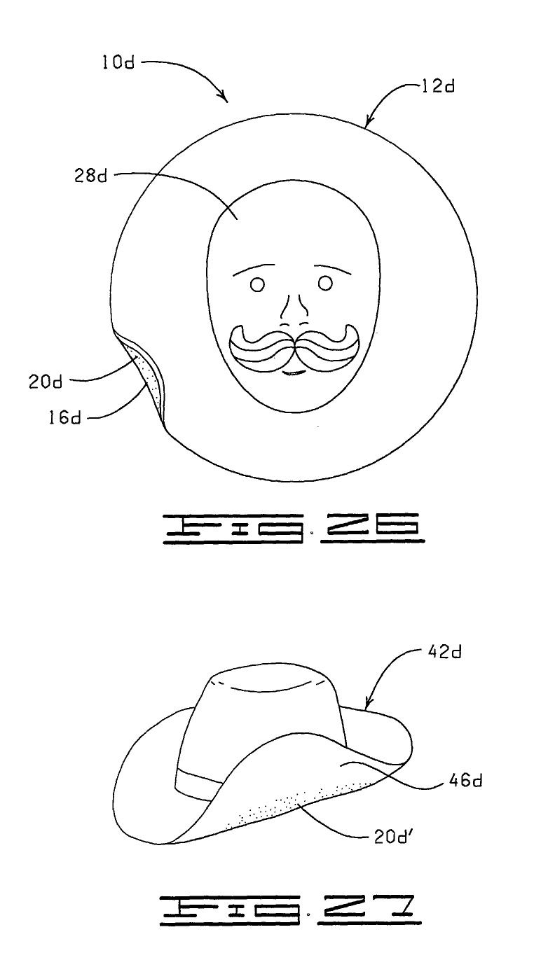

A closure decoration 60c may also be used, as shown and described previously herein, as a decorative completion element, as illustrated in FIG. 25.

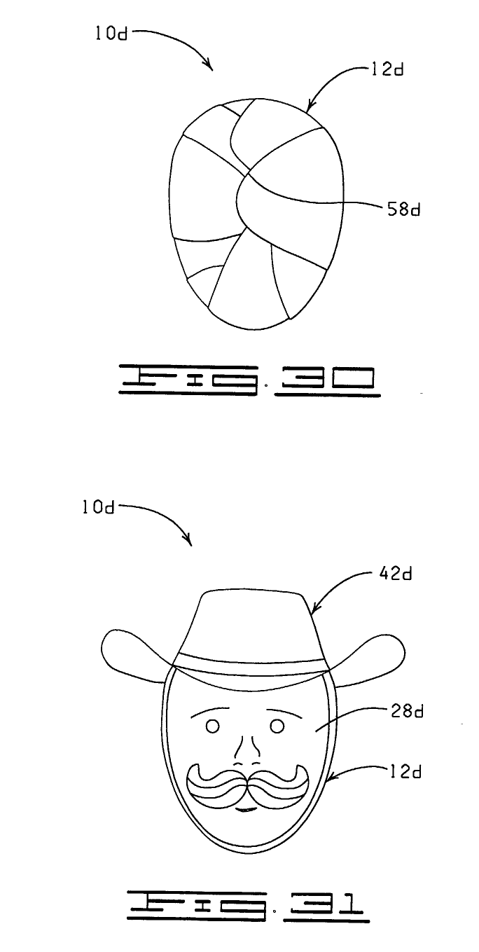

Description of FIGS. 26-31

FIGS. 26-31 illustrate another embodiment of a wrapping material 10d of the present invention. FIG. 26 shows a sheet of material 12d which is constructed similar to the sheets of material 12b and 12c described in detail before and shown in FIGS. 12 and 19, except that the sheet of material 12d has a decorative design 26d comprising a man's face having a mustache.

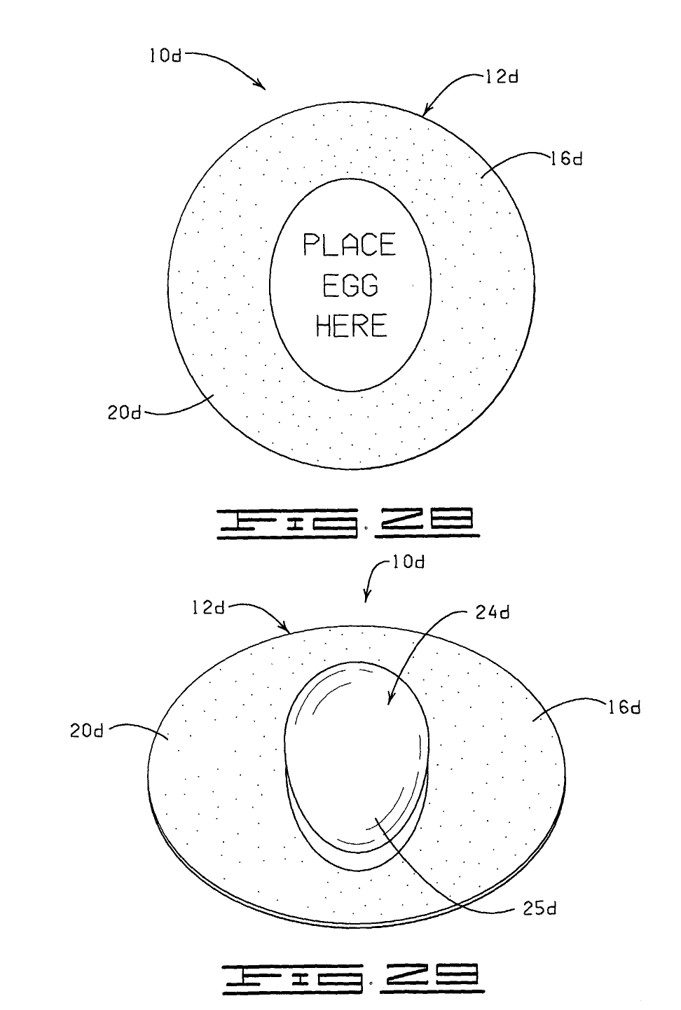

As shown in FIG. 27, an extension 42d is provided; however, the extension 42d has no decorative design thereon, but rather is preformed into a predetermined shape, in this instance, a western-style hat. In addition, in this instance, at least a portion of a lower surface 46d of the extension 42d has a bonding material 54d thereon.

In a method of use, illustrated in FIGS. 28-31, the egg 24 is disposed on forming indicia 22d on a lower surface 16d of the sheet of material 12d, and the sheet of material 12d is wrapped about the egg 24 with bonding material 20d disposed on at least a portion of the lower surface 16d of the sheet of material 12d disposed adjacent an outer surface 25 of the egg 24 such that when the sheet of material 12d is wrapped about the egg 24, the sheet of material 12d is bondingly connected to the outer surface 25 of the egg 24, thereby forming a decorative cover 28d for the egg. The decorative design 26d on the sheet of material 12d comprising a face having a mustache is positioned such that the face is well illustrated on a portion of an outer surface 29d of the decorative cover 28d, as shown in FIG. 31. The extension 42d comprising the hat is then connected to the decorative cover 28d such that the extension 42d connects to the decorative design 26d at a top of the design of the face, namely, the top of the head, therefore connecting the extension 42d in a recognizable manner (a head with a face having a mustache thereon having a hat on the top of the head). The extension 42d extends a distance away from the outer surface 29d of the decorative cover 28d, providing a different visual, aesthetic and decorative effect. The sheet of material 12d is gathered together in an overlapping manner on the opposite side of the outer surface 29d of the decorative cover 28d.

It will be appreciated that all holiday items such as Easter eggs or holiday ornaments shown and described herein will have a closure location and may, optionally, have one or more closure decorations as described previously herein. Further, the holiday items such as Easter eggs or other holiday ornaments may be collected in a bag made from any material described herein. The bag often used will comprise two square or rectangular sheets of material sealed together at the sides around three out of four sides. The unsealed side forms an opening which may be closed via bonding material, or via a pressed frictional engagement. It will be appreciated that other forms of bags or packages may also be used to collect and/or hold the holiday items.

Changes may be made in the embodiments of the invention described herein, or in parts or elements of the embodiments described herein, or in the sequence of steps of the methods described herein, without departing from the spirit and/or scope of the invention as defined in the following claims.

What is claimed is:

1. A method of providing a decorative cover for a holiday item, comprising the steps of:
providing an egg;
providing a sheet of material having an upper surface and a lower surface, the sheet of material having a decorative design disposed on at least a portion of one of the upper and lower surface thereof and forming indicia disposed on at least a portion of one of the upper surface and the lower surface thereof wherein the forming indicia provide instructions for disposing the egg on the sheet of material such that the sheet of material may be wrapped about the egg to form the decorative cover;
disposing the egg on the upper or the lower surface of the sheet of material in accordance with the forming indicia on the sheet of material; and
at least partially wrapping the sheet of material about the egg such that the egg is substantially surrounded and enclosed by the sheet of material, thereby forming the decorative cover for the egg.

2. The method of claim 1 wherein, in the step of providing the sheet of material, the sheet of material includes embossing thereon.

3. The method of claim 1 wherein, in the step of providing the sheet of material, the sheet of material includes a holographic image thereon.

4. The method of claim 1 wherein, in the step of providing the sheet of material, the sheet of material includes a metallic finish thereon.

5. The method of claim 1 wherein, in the step of providing the sheet of material, the sheet of material is opaque, translucent, clear or tinted transparent.

6. The method of claim 1 wherein, in the step of providing the sheet of material, the sheet of material further includes a bonding material disposed on at least a portion of one of the upper and lower surfaces thereof.

7. The method of claim 1 wherein, in the step of providing the sheet of material, the sheet of material further includes at least one extension.

8. The method of claim 7 wherein, in the step of providing the sheet of material, the extension is formed from a second sheet of material.

9. The method of claim 8 wherein, in the step of providing the extension, the extension further includes a shape sustaining element.

10. The method of claim 1 further including a step of adding a closure decoration after the step of wrapping the sheet of material about the egg to form the decorative cover.

11. The method of claim 1 wherein, in the step of providing the sheet of material, the sheet of material is selected from the group consisting of paper, polymeric film, fiber, foil, cloth, burlap and combinations thereof.

12. The method of claim 1 wherein, in the step of providing the sheet of material, the sheet of material is constructed of a plurality of layers of material.

13. The method of claim 1 wherein, in the step of providing the sheet of material, the sheet of material has a thickness in a range from about 0.1 mil to about 10 mil.

14. The method of claim 1 wherein, in the step of providing an egg, the egg is selected from the group consisting of a natural egg, an egg shell, a candy egg, an edible product formed in an egg shape, an artificial egg, and combinations thereof.

15. The method of claim 14 wherein the artificial egg is formed of a material selected from the group consisting of paper, plastic, foil, styrofoam, and combinations thereof.

16. The method of claim 1 wherein the forming indicia is selected from the group consisting of score lines, drawings, creases, printed letters, patterns and numbers.

17. A decorative cover, comprising:
an egg;
a sheet of material having an upper surface and a lower surface, the sheet of material having a decorative design disposed on at least a portion of one of the upper and lower surfaces thereof and forming indicia disposed on at least a portion of one of the upper and lower surfaces thereof wherein the forming indicia provide instructions for disposing the egg on the sheet of material such that the sheet of material may be wrapped about the egg to form the decorative cover; and
wherein the egg is disposed on the upper or the lower surface of the sheet of material in accordance with the forming indicia and the sheet of material is substantially wrapped around the egg to form the decorative cover.

18. The decorative cover of claim 17 wherein the forming indicia is selected from a group of forming indicia consisting of score lines, drawings, creases, printed letters, patterns and numbers.

19. The decorative cover of claim 17 wherein the sheet of material includes embossing thereon.

20. The decorative cover of claim 17 wherein the sheet of material includes a holographic image thereon.

21. The decorative cover of claim 17 wherein the sheet of material includes a metallic finish thereon.

22. The decorative cover of claim 17 wherein the sheet of material is opaque, translucent, clear or tinted transparent.

23. The decorative cover of claim 17 wherein the sheet of material further includes a bonding material disposed on at least a portion of one of the upper and lower surfaces thereof.

24. The decorative cover of claim 17 wherein the sheet of material further includes at least one extension.

25. The decorative cover of claim 24 wherein the extension is formed from a second sheet of material.

26. The decorative cover of claim 25 wherein the extension includes a shape sustaining element.

27. The decorative cover of claim 17 wherein the decorative cover further comprises a closure decoration.

28. The decorative cover of claim 17 wherein the sheet of material is selected from the group consisting of paper, polymeric film, fiber, foil, cloth, burlap and combinations thereof.

29. The decorative cover of claim 17 wherein the sheet of material is constructed of a plurality of layers of material.

30. The decorative cover of claim 17 wherein the sheet of material has a thickness in a range from about 0.1 mil to about 30 mil.

31. The decorative cover of claim 17 wherein the egg is selected from the group consisting of a natural egg, an egg shell, a candy egg, an edible product formed in an egg shape, an artificial egg, and combinations thereof.

32. The decorative cover of claim 31 wherein the artificial egg is formed of a material selected from the group consisting of paper, plastic, foil, styrofoam, and combinations thereof.

33. A decorative cover for packaging an egg, comprising:
a sheet of material having an upper surface and a lower surface, the sheet of material having a decorative design disposed on at least a portion of one of the upper and lower surfaces thereof and forming indicia disposed on at least a portion of one of the upper and lower surfaces thereof wherein the forming indicia provide instructions for disposing the egg on the sheet of material such that the sheet of material may be wrapped about the egg to form the decorative cover; and
wherein when the egg is disposed on the upper or the lower surface of the sheet of material in accordance with the forming indicia, the egg is substantially surrounded and enclosed by the sheet of material, thereby forming the decorative cover for the egg.

34. The decorative cover of claim 33 herein the forming indicia is selected from a group of forming indicia including score lines, drawings, creases, printed letters, patterns and numbers.

35. The decorative cover of claim 33 wherein the sheet of material includes embossing thereon.

36. The decorative cover of claim 33 wherein the sheet of material includes a holographic image thereon.

37. The decorative cover of claim 33 wherein the sheet of material includes a metallic finish thereon.

38. The decorative cover of claim 33 wherein the sheet of material is opaque, translucent, clear or tinted transparent.

39. The decorative cover of claim 33 wherein the sheet of material further includes a bonding material disposed on at least a portion of one of the upper and lower surfaces thereof.

40. The decorative cover of claim 33 wherein the sheet of material has a thickness in a range from about 0.1 mil to about 30 mil.
